(19) United States
(12) Patent Application Publication
(10) Pub. No.: US 2004/0239665 A1
(43) Pub. Date: Dec. 2, 2004

(54) Multiplex command on data line of digital interface display devices

(76) Inventors: Katsushige Otsubo, Kashiwa-shi (JP); Ralph Mesmer, Banks, OR (US); Dinh N. Nguyen, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/452,890

(22) Filed: Jun. 2, 2003

(51) Int. Cl. G09G 5/00

(52) U.S. Cl. 345/211

(57) ABSTRACT

A graphics processing system, methodology, and signal structure are disclosed wherein commands are transmitted from a graphics controller system to a graphics display system along with frame data and synchronization information. The commands instruct the graphics display system to perform certain operations, such as performing video processing on the frame data, controlling parameters of the display, performing power management operation, and well as send information back to the graphics controller system. The signal structure entails transmitting the command signal from the graphics controller system to the graphics display system during the vertical synchronization width and/or horizontal synchronization width respectively of the vertical and horizontal synchronization signals and when a data enable signal is asserted.

### FIELD

This disclosure relates generally to graphic displays, and in particular, to a system and method for generating, transmitting, and processing graphics commands originating from a graphics controlling device and processed by an intelligent graphics display.

### BACKGROUND

Conventional graphic displays used in computing devices, such as desktop computers, laptop computers, and personal digital assistants (PDAs), are typically passive. That is, these displays merely receive frame data and synchronization information from a graphics controller to display the desired information. However, these displays generally do not have the capability of providing graphic processing of the received frame data or other operations.

In today's computing devices, graphic processing is performed either by a graphics controller or processor which resides external to the display unit. Thus, if graphic processing is desired in such devices, the graphics controller or processor applies the desired graphic processing to the frame data, and then sends the processed frame data along with the synchronization information to the display unit. Such graphic processing can include picture rotation such as between portrait and landscape orientations, pixel enhancement, graphic effects, frame width and height variations, etc.

New technology in liquid crystal displays (LCDs), organic light emitting diode display (OLED), and other types of displays have allowed additional circuitry to be embedded within the display hardware. Such additional circuitry can be used to provide additional features for the display, including graphics processing and other functions.

### BRIEF DESCRIPTION OF THE DRAWINGS

FIG. 1 illustrates a block diagram of an exemplary graphics processing system in accordance with an embodiment of the invention;

FIG. 2 illustrates a block diagram of an exemplary graphics controller system in accordance with another embodiment of the invention;

FIG. 3 illustrates a block diagram of an exemplary graphics display system in accordance with another embodiment of the invention;

FIGS. 4A-B illustrate timing diagrams of an exemplary signal structure in accordance with another embodiment of the invention;

FIG. 5 illustrates a timing diagram of an exemplary signal structure in accordance with another embodiment of the invention;

FIG. 6 illustrates a timing diagram of an exemplary signal structure in accordance with another embodiment of the invention;

FIG. 7 illustrates a timing diagram of the exemplary signal structure relating to when configuration information is transmitted from a graphics display system to a graphics controller system in accordance with another embodiment of the invention;

FIG. 8 illustrates a state diagram of an exemplary command processing method in accordance with another embodiment of the invention; and

FIG. 9 illustrates a block diagram of an exemplary graphics processing system in accordance with another embodiment of the invention.

### DETAILED DESCRIPTION

FIG. 1 illustrates a block diagram of an exemplary graphics processing system 100 in accordance with an embodiment of the invention. The system 100 comprises a graphics controller system 102, an intelligent graphics display system 106, and a communications link 104 coupling the graphics controller system 102 to the intelligent graphics display system 106.

In this exemplary embodiment, the graphics controller system 102 is capable of generating and transmitting frame data, synchronization signals, and commands which are sent to the graphics display system 106 by way of the communications link 104. The graphics controller system 102 is also capable of receiving configuration and system status information from the graphics display system 106 by way of the communications link 104.

Also, in this exemplary embodiment, the intelligent graphics display system 106 is capable of receiving the frame data and synchronization information to properly display the frame data on its display screen. In addition, the graphics display system 106 is also capable of interpreting the received commands and perform a specified operation based on the received commands. Further, the graphics display system 106 is capable of generating and transmitting configuration information back to the graphics controller system 102 by way of the communications link.

Thus, in accordance with this exemplary graphics processing system 100, the graphics display system 106 being “intelligent” can perform additional specified functions beyond that of traditional display systems which play a “passive” role by merely displaying the received frame data. The additional functions performed by the intelligent graphics system 106 can be numerous depending on the desired application. Such additional functions may include performing graphics processing on the received frame data, controlling the display, providing power management controls, etc.

In addition, the graphic display system 106 also being “intelligent” can send configuration information back to the graphics controller system 102. Such configuration information device manufacturer, make, model, serial number, version, and other information that identifies the graphics display system 106. Additionally, the graphics display system 106 may further generate and send configuration information received from sensors and other devices in the graphics display system 106. For instance, the graphics display system 106 may include an ambient temperature sensor, an ambient light sensor, and/or other sensors. The graphics display system 106 can transmit information from these sensors back to the graphics controller 102, which in turn may respond by sending one or more additional commands back to the graphics display system 106.

Another embodiment of the invention relates to the manner in which information is communicated between the graphics controller system 102 and the graphics display system 106. As previously discussed, frame data, synchronization information, and commands are sent from the graphics controller system 102 to the graphics display system 106 by way of the communications link 104. In addition, configuration information are sent from the graphics display system 106 to the graphics controller system 102. Therefore, another embodiment of the invention relates to a signal structure that allows for the reliable transfer of information between these two devices while maintaining the required synchronization for proper displaying of the frame data. Such a graphics processing system 100 is discussed in more detail with reference to the following more specific embodiments.

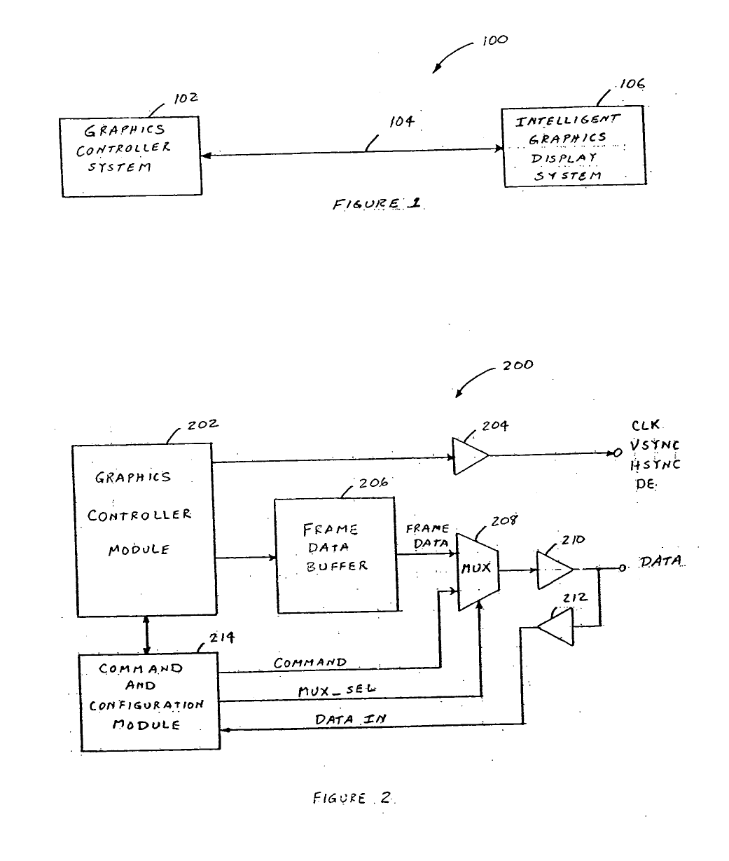

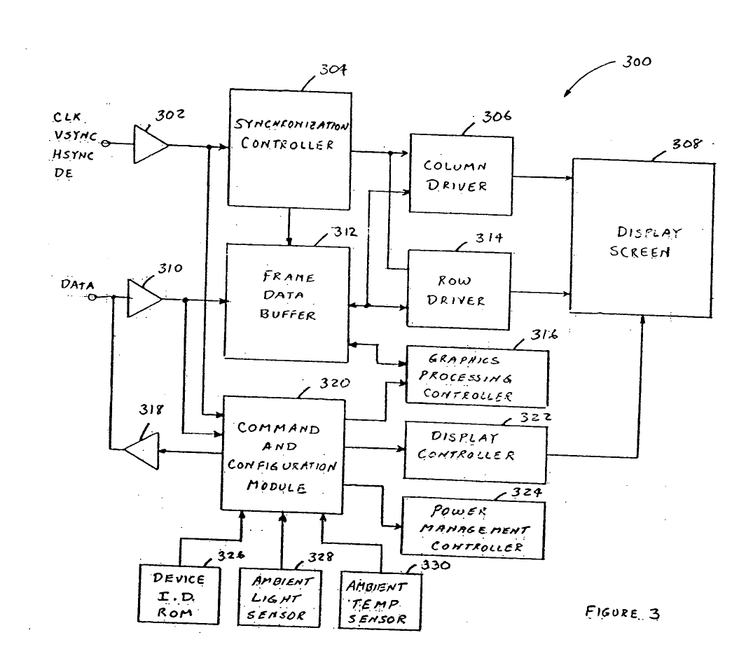

FIG. 2 illustrates a block diagram of an exemplary graphics controller system 200 in accordance with another embodiment of the invention. The graphics controller system 200 is one detailed example of the graphic controller system 102 described with reference to FIG. 1. The graphics controller system 200 may be incorporated as part of a microprocessor, a graphics controller card, a chipset, and other implementations.

In the exemplary embodiment, the graphics controller system 200 comprises a graphics controller module 202, a frame data buffer 206, a command and configuration module 214, a multiplexer 208, and input/output (I/O) buffers 204, 210, and 212.

The graphics controller module 202 generates synchronization signals such as a clock signal (elk), a vertical synchronization signal (Vsync), a horizontal synchronization signal (Hsync), and a data enable signal (DE). These signals are transmitted to the graphics display system through one or more I/O buffers, represented as I/O buffer 204. The graphics controller module 202 is further coupled to the frame data buffer 206 to control the clocking out of the frame data. Additionally, the graphics controller module 202 is coupled to the command and configuration module 214 to exchange information to synchronize the sending of the frame data and commands to the graphics display system.

The frame data buffer 206 stores frame data for delivery to the graphics display system. The command and configuration module 214 generates commands destined for the graphic display system to cause it to perform one or more specified operations. In addition, the command and configuration module 214 receives configuration information sent from the graphics display system by way of I/O buffer 212, and may issue one or more commands in response thereto. Furthermore, the command and configuration module 214 issues a multiplexer control signal MUX_SEL to control the selection of the inputs to the multiplexer 208.

The multiplexer 208 receives as inputs the frame data clocked out of the frame data buffer and the command signal from the command and configuration module 214, and outputs one of these inputs based on the multiplexer control signal MUX_SEL. The multiplexer 208 produces frame data and commands which are sent to the graphics display system by way of the I/O buffer 210.

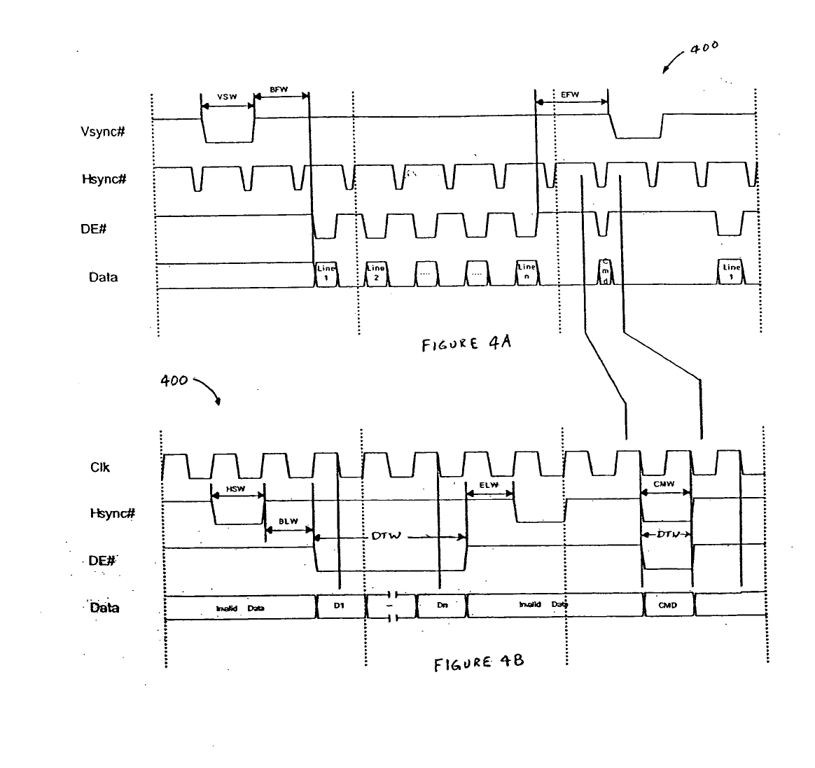

FIG. 3 illustrates a block diagram of an exemplary graphics display system 300 in accordance with another embodiment of the invention. The graphics display system 300 comprises a synchronization controller 304, a frame data buffer 312, a command and configuration module 320, column driver 306, row driver 314, display screen 308, graphics processing controller 316, display controller 322, power management controller 324, device identification read only memory (ROM) 326, ambient light sensor 328, ambient temperature sensor 330, and I/O buffers 302, 310, and 318.

The synchronization controller 304 receives the clock (clk), vertical synchronization (Vsync), horizontal synchronization (Hsync), and data enable (DE) signals from the graphics controller system 200 by way of I/O buffer 302. The synchronization controller 304 uses these signals to control the column and row drivers 306 and 314 in order to synchronize the display of the frame data on the display screen 308. The frame data buffer 312 temporarily stores frame data received from the graphics controller system by way of I/O buffer 310. Using the control signal from the synchronization controller 304, frame data stored in the frame data buffer 312 is transferred to the column and row drivers 306 and 314 for proper display of the frame data on the display screen 308. It shall be understood that the frame data buffer 312 is optional, and the frame data can be sent directly from the I/O buffer 310 to the column and row drivers 306 and 314.

The command and configuration module 320 receives the clock (clk), vertical synchronization (Vsync), horizontal synchronization (Hsync), and data enable (DE) signals from the graphics controller system 200 by way of I/O buffer 302. In addition, the command and configuration module 320 receives commands from the graphics controller system 200 by way of I/O buffer 310. As explained in more detail below, the command and configuration module 320 uses the vertical synchronization (Vsync), horizontal synchronization (Hsync), and data enable (DE) signals to distinguish commands from frame data. The command and configuration module 320 uses the clock (clk) signal to clock in the commands. The command and configuration module 320 interprets the commands, and in response thereto may instruct the graphics processing controller 316, display controller 322, and/or power management controller 324 to perform a specified operation. Also, the command and configuration module 320, in response to the received commands, may receive configuration information generated and/or stored in the device I.D. ROM 326, the ambient light sensor 328, and the ambient temperature sensor 330, and transmit it back to the graphics controller system 200 by way of I/O buffer 318.

The graphics processing controller 316, display controller 322, and power management controller 324 are merely some examples, in many, of controllers that perform a specified operation based on the command received by the command and configuration module 320. For instance, the graphics processing controller 316 may perform graphics processing on the frame data stored in the frame data buffer 312. Examples of graphics processing include image frame resizing, image mirroring, image rotation, etc. The display controller 322 may perform some display processing such as changing the brightness, contrast, horizontal and vertical margins, etc. The power management controller 330 may control the power consumption of the graphics display system 300. These controllers are merely examples, many other controllers with different application may be used.

The device I.D. ROM 326, ambient light sensor 328, and the ambient temperature sensor 330 are also merely examples, of many, of information-generating devices that are used by the command and configuration module 320 to send configuration information back to the graphics controller system 200. For instance, the device I.D. ROM 326 may contain information regarding the identity of the graphics display system 300 such as the device manufacturer, make, model, serial number, version, and other information that identifies the graphics display system 106. Such information may be used by the graphics controller system 200, for example, to determine whether the graphics display system 300 is capable of processing only a specified set of commands or none at all. The ambient light sensor generates information related to the intensity of the ambient light. Such information may be used by the graphics controller system 200, for example, to issue a command to the graphics display system 300 to adjust the brightness of the display 308. The ambient temperature sensor 330 provides information regarding the environment temperature. These information-generating devices are merely examples, many other devices with different application may be used.

FIGS. 4A-B illustrate timing diagrams of an exemplary signal structure 400 in accordance with another embodiment of the invention. The signal structure 400 are the signals and timing relationship of the information sent between the graphics controller system 200 and the graphics display system 300. In particular, FIG. 4A illustrates a timing diagram of the signal structure 400 with a broader time window, and FIG. 4B illustrates a timing diagram of the signal structure 400 with a narrower time window.

The signal structure 400 comprises a vertical synchronization signal (Vsync#) characterized as having a vertical synchronization width (VSW) (i.e. when Vsync# is asserted) to indicate a vertical blank period. The signal structure 400 further comprises a horizontal synchronization signal (Hsync#) characterized as having a horizontal synchronization width (HSW) (i.e. when Hsync# is asserted) to indicate a horizontal blank period. Additionally, the signal structure 400 comprises a data enable (DE#) signal characterized as having a data transmission window (DTW) (i.e. when DE# is asserted) to indicate the transfer of frame data or command. The signal structure 400 also comprises a data signal containing frame data or commands. Finally, the signal structure 400 comprises a clock signal that assists in clocking frame data and commands as well as maintaining a timing relationship for the signals of the signal structure 400.

As illustrated in the timing diagrams, frame data is transferred from the graphics controller system 200 to the graphics display system 300 when the vertical and horizontal synchronization signals (Vsync#) and (Hsync#) are not asserted and the data enabled (DE#) is asserted. The time width between the end of the vertical synchronization width (VSW) and the beginning of the next frame data transfer period is referred to as the Before Frame Wait (BFW). The time width between the end of the frame data transfer period and the beginning of the next vertical synchronization width (VSW) is referred to as the End of Frame Wait (EFW). The time width between the end of the horizontal synchronization width (HSW) and the beginning of the next frame data transfer period is referred to as the Before Line Wait (BLW). The time width between the end of the frame data transfer period and the beginning of the next horizontal synchronization width (HSW) is referred to as the End of Line Wait (ELW).

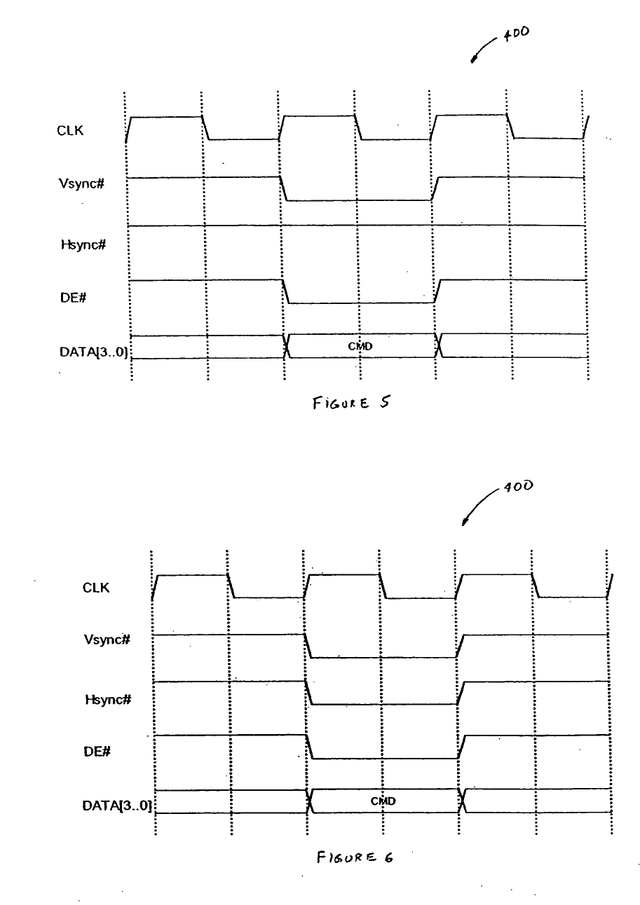

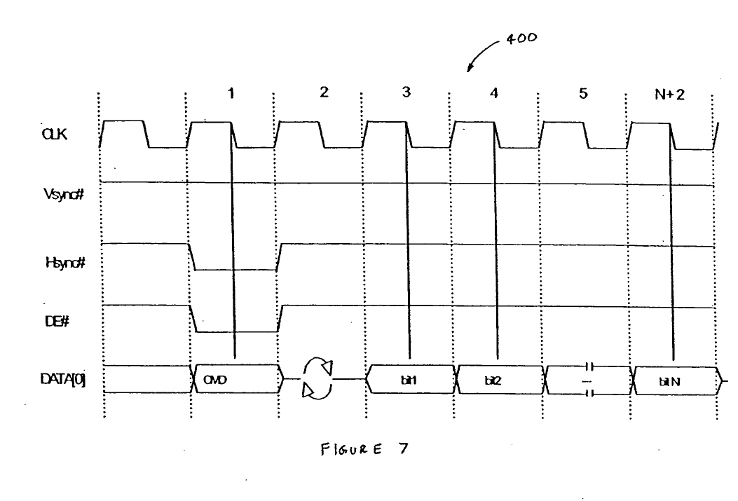

Such timing relationships between the horizontal and vertical synchronization signals and the frame data signal allows the signal structure 400 to be compatible with prior graphics processing systems. However, the signal structure 400 further includes timing relationships for transmitting commands from a graphics controller system to the graphics display system. As shown in FIG. 4B, commands from the graphics controller system 200 to the graphics display system 300 may be transmitted on the data line when both the horizontal synchronization (Hsync#) and the data enable (DE#) signals are asserted. The horizontal synchronization (Hsync#) being asserted is one way to distinguish when a command is being transmitted from when frame data is being transmitted. The data enable (DE#) signal being asserted merely indicates that either frame data or a command is being transmitted. In addition, commands may also be transmitted when the data enable (DE#) signal and the vertical synchronization (Vsync#) are asserted (See FIG. 5). Also, commands may be transmitted when the data enable (DE#) signal, the vertical synchronization (Vsync#), and the horizontal synchronization signals (Hsync#) are asserted (See FIG. 6).

As previously discussed, some commands sent from the graphics controller system to the graphics display system relate to requests for configuration information. For instance, the graphics controller system may send a command to the graphics display system requesting identification information. And/or, the graphics controller system may send a command to the graphics display system requesting ambient light information. And/or, the graphics controller system may send a command to the graphics display system requesting ambient temperature information. Whatever information the graphics controller system is requesting, the signal structure 400 allows for the graphics controller system to receive configuration information from the graphics display system.

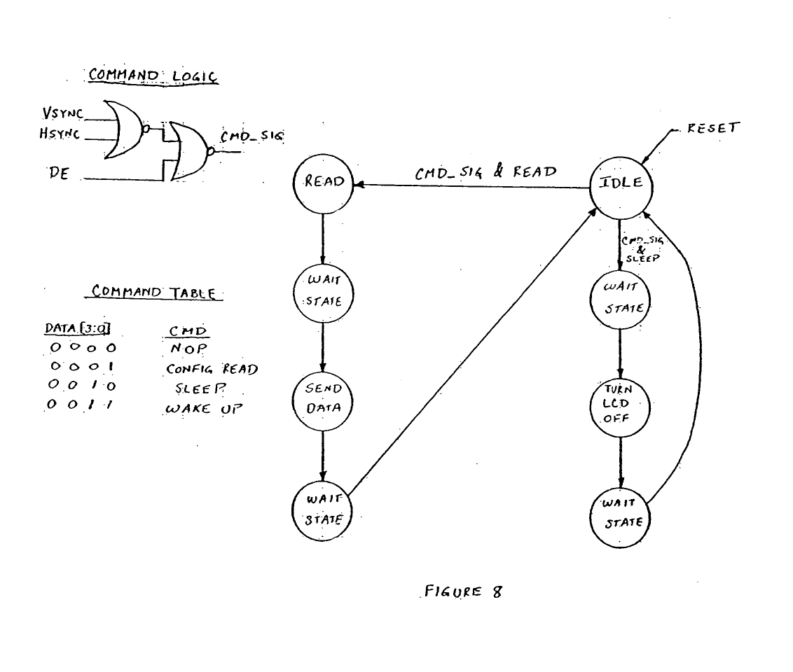

FIG. 7 illustrates a timing diagram of the exemplary signal structure 400 relating to when configuration information is transmitted from the graphics display system to the graphics controller system. As previously discussed, commands generated by the graphics controller system may be transmitted to the graphics display system when the horizontal synchronization (Hsync#) and/or vertical synchronization (Vsync#) signals are/is asserted. Accordingly, in the example shown in FIG. 7, the graphics controller system generates and transmits a command during clock cycle one (1). Note that the horizontal synchronization (Hsync#) and data enable (DE#) signals are asserted during clock cycle one (1). After transmission of the command, there may be a wait period of one or more clock cycles (e.g. clock cycle two (2)) for the graphic display system to respond to the request command. This wait period is the turn-around cycle during which time, to avoid bus contention, the graphic controller turns off its drivers before the graphic display can turn on its drivers. Then, the graphics display system transmits the configuration information data during subsequent clock cycles, such as clock cycles three (3) to N+2 as shown in FIG. 7.

With reference to FIG. 2 and the timing diagrams, when the graphics controller system 200 is transmitting frame data to the graphics display system 300, the graphics controller module 202 deasserts the vertical synchronization (Vsync#) and horizontal synchronization (Hsync#) signals, and asserts the data enable (DE#) signal. Also, the graphics controller module 202 notifies the command and configuration module 214 that frame data is being transmitted. The command and configuration module 214, in turn, issues a multiplexer select signal MUX_SEL that causes the multiplexer 208 to output frame data. Alternatively, the graphics controller module 202 may also issue such multiplexer select signal MUX_SEL. In addition, the graphics controller module 202 causes the frame data to be clocked out of the frame data buffer and transmitted to the graphics display controller 300 by way of the multiplexer 208, I/O buffer 210, and communications link.

When the graphics controller system 200 is transmitting a command to the graphics display system 300, the command and configuration module 214 notifies the graphics controller module 202 that a command is to be transmitted. In response, the graphics controller module 202 asserts either or both the vertical synchronization (Vsync#) and horizontal synchronization (Hsync#) signals, and asserts the data enable (DE#) signal. The command and configuration module 214 also issues a multiplexer select signal MUX_SEL that causes the multiplexer 208 to output the command. Alternatively, the graphics controller module 202 may also issue such multiplexer select signal MUX_SEL. Then, the graphics controller module 202 generates the command which is transmitted to the graphics display controller 300 by way of the multiplexer 208, I/O buffer 210, and communications link.

If such a command is a request for configuration information, following the transmission of the command, the graphics controller module 202 deasserts the vertical and horizontal synchronization signals (Vsync#) and (Hsync#) and also the data enable (DE#) signal. Subsequently, the command and configuration module 214 receives the configuration information data from the graphics display system 300 by way of the communications link and the I/O buffer 212. The command and configuration module 214 may use this information to issue a subsequent command to the graphics display system 300. How the graphics display system 300 processes commands will now be discussed.

With reference to FIG. 3 and the timing diagrams, when the graphics controller system 200 is transmitting frame data to the graphics display system 300, the synchronization controller 302 receives the deasserted the vertical synchronization (Vsync#) and horizontal synchronization (Hsync#) signals, and asserted data enable (DE#) signal by way of the communications link and I/O buffer 302. In response to these signals, the synchronization controller 304 may instruct the frame data buffer 312 to receive frame data transmitted by the graphics controller system 200 by way of the communications link and the I/O buffer 310. Subsequently, the synchronization controller 304 causes a transfer of the frame data stored in the frame data buffer 312 to the column and row drivers 306 and 314 to properly display the frame data on the display screen 308. Alternatively, if the graphics display system 300 does not have a frame data buffer 312, the synchronization controller 304 operates the column and row drivers 306 and 314 to receive and process the frame data to properly display the frame data on the display screen 308.

When the graphics controller system 200 is transmitting a command to the graphics display system 300, the command and configuration module 302 receives the asserted vertical and/or horizontal synchronization signals (Vsync#) and (Hsync#), and the asserted data enable (DE#) signal. During the time period, the command and configuration module 320 receives a command from the graphics controller system 200 by way of the communications link and the I/O buffer 310. In response to this command, the command and configuration module 320 may instruct one or more of its controllers, such as graphics processing controller 316, display controller 322, and power management controller 324, to perform a specified function. And/or, in response to the received command, the command and configuration module 320 may read configuration information from one of its information-generating modules, such as the device I.D. ROM 326, the ambient light sensor 328, and the ambient temperature sensor 330.

When the graphics display system 300 is to transmit configuration information back to the graphic controller system 200, the command and configuration module 214 waits one or more clock cycles after the vertical and/or horizontal synchronization signals (Vsync#) and (Hsync#) are deasserted, as well when the data enable (DE#) is deasserted. This wait period is needed to avoid bus contention. When all these signals are deasserted, the command and configuration module 320 transmits the requested configuration information to the graphics controller system 200 by way of the I/O buffer 318 and the communications link.

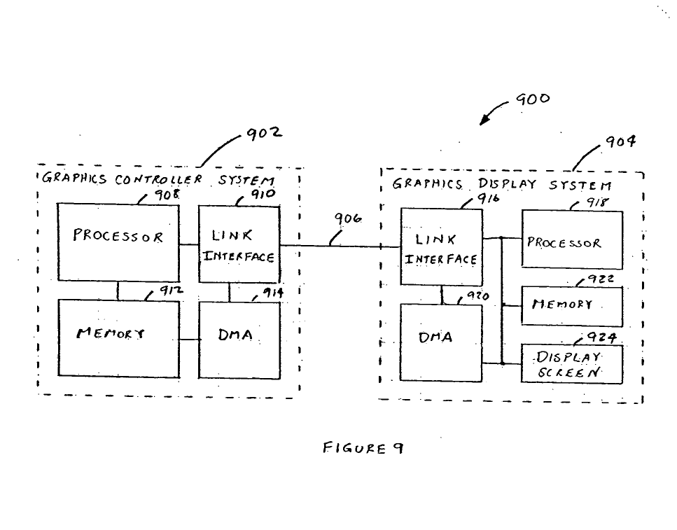

FIG. 8 illustrates a state diagram of an exemplary command processing method in accordance with another embodiment of the invention. As previously discussed, a command is transmitted when the vertical synchronization (Vsync#) and/or the horizontal synchronization (Hsync#) signals are/is asserted, and when the data enable (DE#) signal is asserted. In the exemplary embodiment, an asserted signal is a logic low (but, it could also be a logic high). Thus, the command logic shown in FIG. 8 illustrates when the command signal CMD_SIG is issued. Also shown in FIG. 8 is an exemplary command table illustrating some possible commands for the graphics display system to process.

With reference to the state diagram, upon the command and configuration module 320 receiving a reset signal upon start-up of the graphics display system 300, the command and configuration module 320 enters an idle state. During the idle state, the command and configuration module 320 monitors the command signal CMD_SIG to determine when a command has issued.

When, for example, a command for configuration information, has issued, the command and configuration module 320 reads the specified configuration information from one of the information-generating devices, such as device I.D. ROM 326, ambient light sensor 328, and ambient temperature sensor 330. After the configuration is read, the command and configuration module 320 enters a wait state to allow time for the communication link to be available for the transmission of the configuration information back to the graphics controller system 300. Then, the command and configuration module 320 transmits the configuration information data back to the graphics controller system 200. Then, the command and configuration module 320 enters another wait state so that the communications link is available again for the transmission of another command. After this wait state, the command and configuration module 320 returns back to the idle state.

When, for example, a command relates to performing a particular operation, such as placing the graphics display system 300 in a low power (“sleep”) mode, the command and configuration module 320 enters a wait state to interpret the command. After the command has been interpreted, the command and configuration module 320 instructs one of its controllers, such as the power management controller 324, to perform the specified operation, such as place the graphics display system 300 in a low power (“sleep”) mode. Then, the command and configuration module 320 enters another wait state so that the communications link is available again for the transmission of another command. After this wait state, the command and configuration module 320 returns back to the idle state.

The graphics controller system and the graphics display system described herein may be implemented with dedicated hardware, or with a processor controlled by one or more software modules stored in a computer readable medium, or a combination of dedicated hardware and software-controlled processor.

FIG. 9 illustrates a block diagram of an exemplary graphics processing system 900 in accordance with another embodiment of the invention. The graphics processing system 900 comprises a graphics controller system 902, a graphics display system 904, and a communications link 906. The graphics controller system 902, in turn, comprises a processor 908, a link interface 910, a memory 912, and optionally a direct memory access (DMA) device 914. The processor 902, under the control one or more software modules, is capable of generating the signals according to the signal structure 400 described above and processing the configuration information received from the graphics controller system 904.

The graphics display system 904, in turn, comprises a processor 918, a link interface 916, a memory 922, a display screen 924, and optionally a direct memory access (DMA) device 914. The graphics display system 904, in turn, comprises a processor 918, a link interface 916, a memory 922, a display 924, and optionally a direct memory access (DMA) device 920. The processor 918, under the control of one or more software modules, is capable of processing the signals according to the signal structure 400 described above, including the transmission of configuration information back to the graphics controller system 902.

In the foregoing specification, specific embodiments of the invention have been described. It will, however, be evident that various modifications and changes may be made thereto without departing from the broader spirit and scope of the embodiments of the invention. The specification and drawings are, accordingly, to be regarded in an illustrative rather than a restrictive sense.

It is claimed:

1. A method comprising:
producing a vertical synchronization signal;
producing a horizontal synchronization signal;
producing frame data;
producing a command signal; and
transmitting said vertical synchronization signal, said horizontal synchronization signal, said frame data, and said command signal to a graphic display system.

2. The method of claim 1, wherein said command signal causes a specified operation to be performed by said graphics display system.

3. The method of claim 1, wherein said command signal is transmitted during a vertical synchronization width of said vertical synchronization signal.

4. The method of claim 1, wherein said command signal is transmitted during a horizontal synchronization width of said horizontal synchronization signal.

5. The method of claim 1, wherein said command signal is transmitted during a vertical synchronization width and a horizontal synchronization width respectively of said vertical and horizontal synchronization signals.

6. The method of claim 1, further comprising producing and transmitting a data enable signal to said graphic display system to indicate that a command and/or frame data is being transmitted to said graphics display system.

7. The method of claim 6, wherein said command signal is transmitted when said data enable signal is asserted.

8. The method of claim 1, wherein said command signal relates to a request for configuration information, and further comprising receiving configuration information data from said graphics display system.

9. The method of claim 8, wherein said vertical and horizontal synchronization signals and said data enable signal are non-asserted during said receiving of configuration information data from said graphics display system.

10. A method comprising:
receiving a vertical synchronization signal;
receiving a horizontal synchronization signal;
receiving frame data;
generating an image on a display based on said vertical and horizontal synchronization signals and said frame data;
receiving a command signal; and
performing a specified operation based on said command signal.

11. The method of claim 10, wherein performing said specified operation comprises instructing a controller to perform a specified function.

12. The method of claim 11, wherein said specified function comprises performing graphics processing on said frame data.

13. The method of claim 11, wherein said specified function comprises controlling said display.

14. The method of claim 11, wherein said specified function comprises performing power management of said display.

15. The method of claim 10, wherein performing said specified operation comprises transmitting information to a graphics controller system.

16. The method of claim 15, wherein said information comprises identity information of said display.

17. The method of claim 15, wherein said information comprises ambient light information.

18. The method of claim 15, wherein said information comprises ambient temperature information.

19. The method of claim 10, wherein said command signal is received during a vertical synchronization width of said vertical synchronization signal.

20. The method of claim 10, wherein said command signal is received during a horizontal synchronization width of said horizontal synchronization signal.

21. The method of claim 10, wherein said command signal is received during a vertical synchronization width and a horizontal synchronization width respectively of said vertical and horizontal synchronization signals.

22. The method of claim 10, further comprising receiving a data enable signal which indicates that a command and/or frame data is being received.

23. The method of claim 22, wherein said command signal is transmitted when said data enable signal is asserted.

24. A signal structure, comprising:
a vertical synchronization signal;
a horizontal synchronization signal;
a frame data signal; and
a command signal.

25. The signal structure of claim 24, wherein said command signal is transmitted during a vertical synchronization width of said vertical synchronization signal.

26. The signal structure of claim 24, wherein said command signal is transmitted during a horizontal synchronization width of said horizontal synchronization signal.

27. The signal structure of claim 24, wherein said command signal is transmitted during a vertical synchronization width and a horizontal synchronization width respectively of said vertical and horizontal synchronization signals.

28. The signal structure of claim 24, further comprising receiving a data enable signal to indicate that said command signal and/or frame data is being received.

29. The signal structure of claim 24, further comprising configuration information relating to a graphics display system.

30. The signal structure of claim 29, wherein said configuration information is transmitted when said vertical and horizontal synchronization signals are non-asserted.

31. A graphics controller system, comprising:
a memory to store frame data;
a graphics controller module to generate a clock signal, a vertical synchronization signal, a horizontal synchronization signal, and a data enable signal; and
a command module to generate a command signal to control a graphics display system.

32. The graphics controller system of claim 31, wherein said command module causes a transmission of said command signal during a vertical synchronization width and/or a horizontal synchronization width respectively of said vertical and horizontal synchronization signals, and when said data enable signal is asserted.

33. The graphics controller system of claim 31, wherein said command module is capable of receiving and responding to information received from said graphics display system.

34. A computer readable medium comprising one or more software modules to:
produce a vertical synchronization signal;
produce a horizontal synchronization signal;
produce frame data;
produce a command signal; and
transmit said vertical synchronization signal, said horizontal synchronization signal, said frame data, and said command signal to a graphic display system.

35. The computer readable medium of claim 34, wherein said one or more software modules causes said command signal to be transmitted during a vertical synchronization width and/or a horizontal synchronization width respectively of said vertical and horizontal synchronization signals.

36. The computer readable medium of claim 34, wherein said one or more software modules causes a data enable signal to be transmitted to said graphics display system which indicates that said command signal and/or frame data is also being transmitted.

37. A graphics display system, comprising:
a display screen;
a column driver to receive frame data and to drive said display based on said frame data;
a row driver coupled to receive frame data and to drive said display based on said frame data;
a synchronization controller to receive a clock signal, a vertical synchronization signal, a horizontal synchronization signal, and a data enable signal, and to control said column driver and said row driver in accordance with said clock signal, said vertical synchronization signal, said horizontal synchronization signal, and said data enable signal; and
a command module to receive said clock signal, said vertical synchronization signal, said horizontal synchronization signal, said data enable signal, and a command signal, and to perform a specified operation based on said command signal.

38. The graphics display system of claim 37, further comprising a controller, and wherein said specified operation comprises causing said controller to perform a particular function.

39. The graphics display system of claim 37, further comprising an information-generating device, and wherein said specified operation comprises reading information from said information-generating device and transmitting said information to a graphics controller system.

40. A computer readable medium comprising one or more software modules to:
receive a vertical synchronization signal;
receive a horizontal synchronization signal;
receive frame data;
receive a command signal;
produce an image on a display screen in accordance with said vertical synchronization signal, said horizontal synchronization signal, and said frame data; and
perform a specified operation based on said command signal.

41. The computer readable medium of claim 40, wherein said one or more software modules to process said command signal received simultaneous with a vertical synchronization width and/or a horizontal synchronization width respectively of said vertical and horizontal synchronization signals.

42. The computer readable medium of claim 40, wherein said one or more software modules to process a data enable signal that indicates that said command signal and/or frame data is available for receiving.

43. The computer readable medium of claim 40, wherein said one or more software modules to transmit information if said command signal is a request for said information.
